(19) United States
(12) Patent Application Publication
(10) Pub. No.: US 2004/0227423 A1
(43) Pub. Date: Nov. 18, 2004

(54) Multiple shafts multiple discs armature electric motor

(76) Inventor: Sydney A. Cunningham, Brooklyn, NY (US)

Correspondence Address: SYDNEY A. CUNNINGHAM, 1368 NEW YORK AVENUE, BROOKLYN, NY, 11203, US

(21) Appl. No.: 10/438,458

(22) Filed: May 16, 2003

(51) Int. Cl. H02K 16/00

(52) U.S. Cl. 310/114

(57) ABSTRACT

This innovation of an electric motor is designed to replace the internal combustion engine, and will power many form of transportation and equipments. By using plurality of armature shafts with plurality of armatures disposed on each shaft, which work together as a unit to develop any required amount of torque. A torque coupling gear box having gear wheels, and shafts, are coupled to each different one of the armature shaft, and combine all of its torque into motive power at the output. Base on the components that is being used, and also the form in which they are configured, point to a device with tremendous output capability; for a small fraction of input. With modification, this innovation can also be use to generate electric current with the same tremendous efficiency, while operating pollution free.

### BACKGROUND OF THE INVENTION

1. Field Of Invention

The present invention relates to electric motor, and more particularly to multiple shafts multiple discs armatures motor which is a novel approach in solving the energy and pollution problem. For decades, there has been a need for an electric motor which is efficient enough to replace the conventional fossil fuel burning internal combustion engine. My present innovation will accomplish those requirement and more, this device can be made to produce the required torque that is needed to power many different type of transportations and equipments. In my motor two or more parallel armature shafts with any required nomber of two or more disc shape poleface, and two or more disc shape armature windings are disposed on each armature shaft. In the center of each poleface and each armature a aperture is provided from which said armature shaft intresect, with each armature winding position between two polefaces on the said shaft. Each armature is attach to said shaft which rotate through each poleface, said armature shafts are supported between a first and a second endframe from which they rotate on bearings; with shafts extending beyond said first endframe. Elongated support strut are fixedly mounted between endframes, means for attaching poleface to said strut. Torque coupling gearbox having housing with spur gears, idle gears, and shaft within said housing; idle gears situated between spur and drive gear and in engagement with both gears spur gears shafts extended a short distance beyond said housing and attach to different armature shaft.

My motor provide two new ways of increasing torque to a tremendous level, (1) by multiple shafts and (2) by multiple armature; this combination will accomplish the needs of the future electric motor. The armature and poleface on each shaft form individual motor on that shaft, and therefore combine the total torque to each said shaft. A duct is provided along each armature shaft which carry connecting wires from armatures to the commutator where it is connected; such wire is not shown. It is safe to state without proof that:

A armature shaft that is rotating five armatures is more cost effective than said shaft rotating one of said armature. This is why my motor represent a win win situation. The torque from each armature is apply to each spur gear which transfer said torque via idle gears to a drive gear which rotate a output shaft, said drive gear combined the total output on to said output shaft ready for use.

2. Description Of The Prior Art

The prior art electric motor has served us very well over the years, nevertheless, it has a number of drawback which limit its potential to this day. Some of these are the single armature where in order to increase torque, the size and weight of the motor must also be increase; also the concave poleface which permit only about 67% of the magnetic lines to be cut. When a motor of the prior art is designed and manufactured, it remain that way until its usefulness is ended.

My design permit one to change a number of those components utilized, without major alteration of the overall configuration; such as poleface, armature, and shaft. This degrees of versatility allow the motor to be configured for specific needs without major redesign.

### SUMMARY OF THE INVENTION

It is therefore the prime object of the present invention to provide a multiple shafts multiple discs armature electric motor, wherein two or more armatures and associated polefaces are disposed on each of said two or more shafts in a single housing between common endframes so as to operate as a unit.

Another object of the present invention is to provide a multiple shafts multiple armatures electric motor with increase torque at a moderate size and weight for powering many form of transportations vehicles and other type of equipments where fossil fuel internal combustion engines are currently employed.

Still another object of the present invention to provide a multiple shafts multiples armatures motor including a torque coupling gearbox a device which is used to connect the multiple armature shafts so as to combine the torque created by the individual armature on said shaft.

Yet another object of the present invention to provide a multiple shafts multiple armatures motor which can be easily modified to incorporate any required number of armatures, without changing the basic design.

Then another object of the present invention wherein a torque coupling gearbox having housing, with spur gears, idle gears, and drive gear therein; each gear wheel rotate on individual shaft, spur gear shafts extended a short distant beyond said housing and couple with individual armature shaft.

### BRIEF DESCRIPTION OF THE DRAWINGS

FIG. 1 is an isometric view showing a first preferred embodiment of a multiple shafts multiple discs armature motor of the present invention which show four armature shafts;

FIG. 2 is an isometric view showing a first preferred embodiment of a multiple shafts multiple discs armature motor the same as that of FIG. 1, but with three armature shafts;

FIG. 3 is an isometric view showing a first prefferred embodiment of a multiple shafts multiple discs armature motor the same as that of FIG. 1, but with two armature shafts.

FIG. 4 is an isometric view showing one of many poleface sleve;

FIG. 5 is an isometric view showing one of two endframes used in FIG. 1;

FIG. 6 is an isometric view showing one of two endframes used in FIG. 2;

FIG. 7 is an isometric view showing one of two endframes used in FIG. 3; note that each endframe has shaped according to the number of armature shafts it designed to carry;

FIG. 8 is an isometric view showing one of the many armature winding;

FIG. 9 is an isometric view showing two permanent-magnet polefaces.

FIG. 10 is an isometric view showing one of the many armature shaft used in the embodiments;

FIG. 11 is an isometric view of an elongated support strut;

FIG. 12 is a cross sectional view of the torque coupling gearbox;

FIG. 13 is an isometric view showing one of the spurgear shaft from the torque coupling at the point where it coupled with one of the armature shaft.

### DESCRIPTION OF THE PREFERRED EMBODIMENTS

There are many new features to the present invention, two of which are the multiple shafts and multiple discs armature motor which may be constructed with different number of two or more shafts, or two or more armature windings; without changing the basic design. Duplication of parts and slight modification of the endframes and torque coupling mechanism is required, well within the skill of those of ordinary skill in the art of electric motor design; are require to reconfigure the motor for different number of a component.

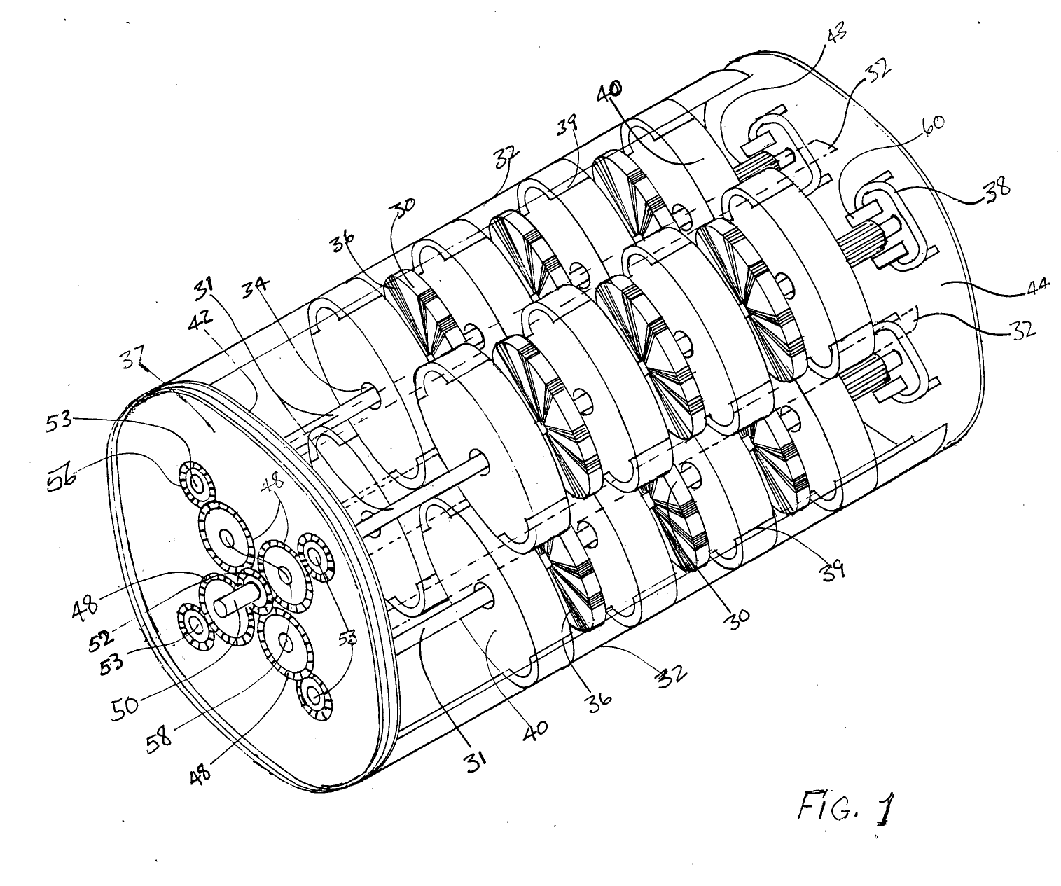

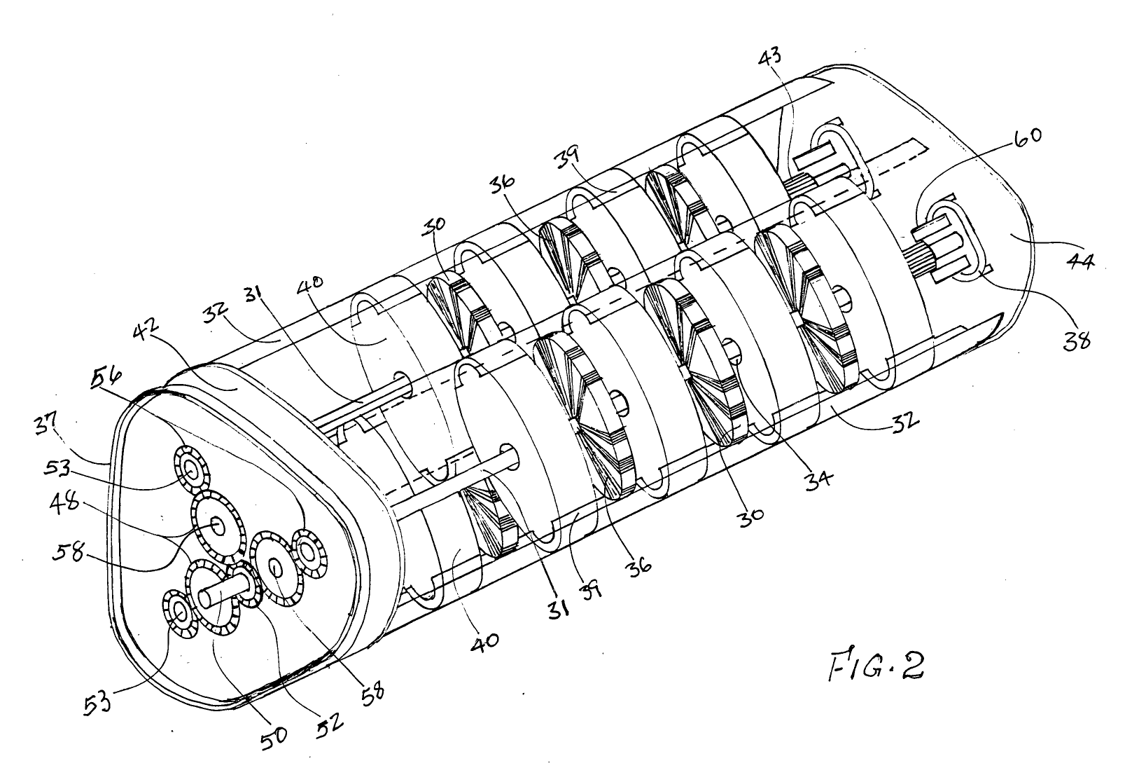

For the purposes of illustration, the first preferred embodiment of the invention illustrated in FIG. 1 is shown having four shafts and three armatures on each shaft; the second preferred embodiment illustrated in FIG. 2 is shown having three armature shafts and three armatures on each shaft, a third preferred embodiment illustrated in FIG. 3 is shown having two armature shafts and three armatures on each shaft. In each embodiment the basic parts are the same, they change if the required number of armature shafts or armatures are change.

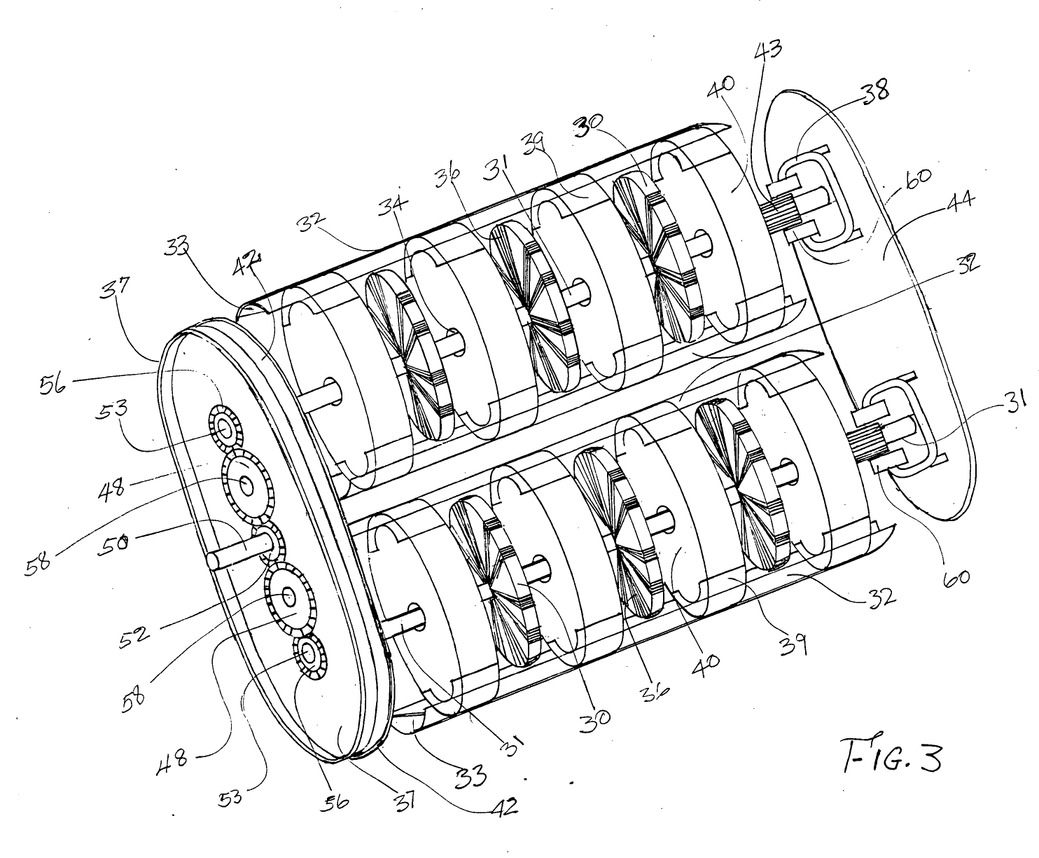

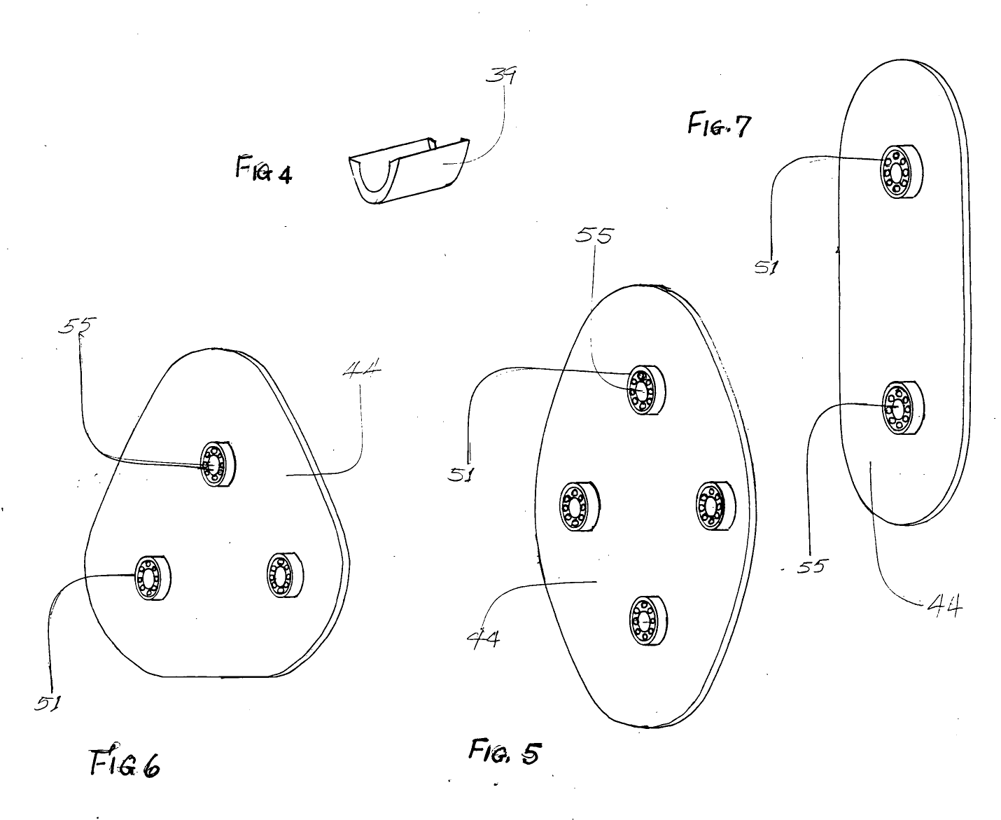

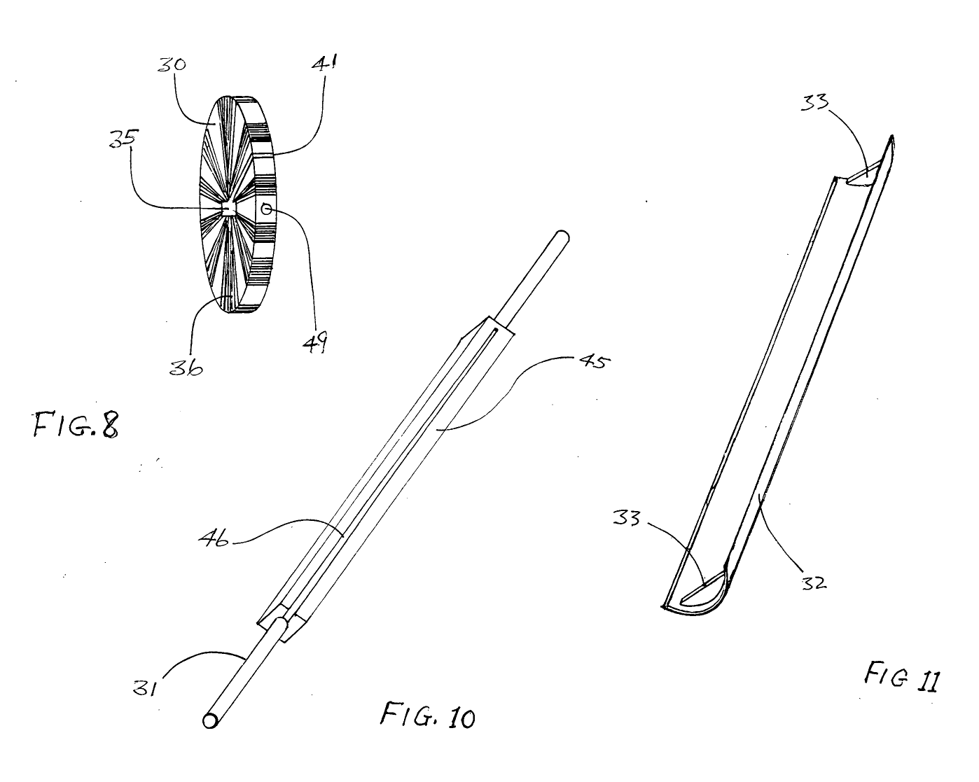

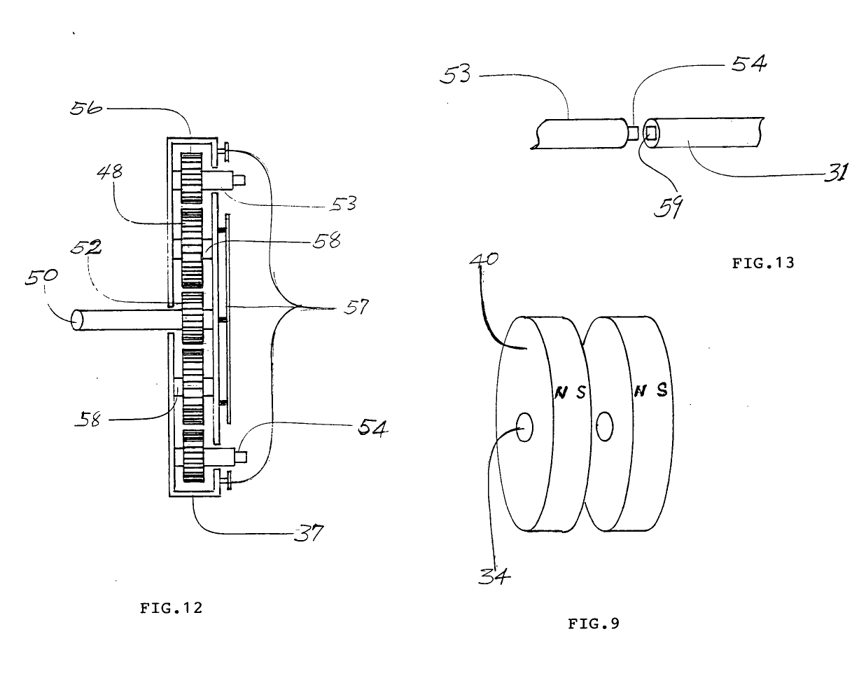

The multiple shafts multiple armatures motor of the present invention for most part a unconventional design, including two or more armature shafts 31. Said shafts are fabricated with a square middle section 45 and a duct 46 cut into the length of said section 45 and exit at one end, a commutator 43 is is attach to that end of shafts 31 where duct 46 exit Magnet poleface 40 with aperture 34 from which shaft 31 intersect and rotate therethrough without touching said poleface 40. Armature 30 is fabricated from metal and having armature windings 36 disposed thereon, a slot 41 is provided on said armature to facilitate armature windings. A square aperture 35 which permit armature 30 to be fitted smugly onto section 45 of said armature shaft and secured thereto by attachment means through aperture 49 on said armature, the center for each aperture in both poleface and armature are taken as one half the component diameter. Poleface sleeve 39 is attachment fabricated to the contour of poleface 40, sleeve 39 is attach to each poleface 40 which provide fixedly support for said 40. Both endframes 42 and 44 are the same, except that the brush assembly 38 is attach to endframe 44, armature shafts 31 are rotatably supported between each said endframe, said shafts 31 rotate on bearings 51 through shaft opening 55. Associated with said endframes are elongated support strut 32 of a concave design, 32 is also designed to the contour of sleeve 39 or poleface 40, which is the basic outline of the preferred embodiment. support brace 33 is used for both the strenghtening of strut 32 and also fixedly secured each of said endframe which define the perimeter of the device. Each poleface 40 and armature 30 are position so as to secured the small air-gap required between poleface and rotating armature to maintain that fix position, sleeve 39 is fasten to strut 32 by attachment means. Armature 30 is also securely anchored to said shaft by attachment means through aperture 49 in said armature. Connecting wires from each armature winding 36 is not shown, but said wires will be run in duct 46 from one armature 30 to the other, and finally connected to commutator 43. On each of the preferred embodiment FIGS. 1-3 where the bearings and shafts in the endframe 42 cannot be seen, (those bearings would be 47 and shafts opening 29, only if these information are required). A torque coupling gearbox having housing 37 is shown in each embodiment of the present invention, a cross section view of said 37 is also shown at FIG. 12 detach from the multiple shafts motor. Each gear in the coupling gearbox rotate on independent shaft, spur gear 56 rotate on shaft 53 which extend a short distant beyond the housing 37. Each of said shaft 53 couple with each different armature shaft 31 by coupling means provided at 54 and 59 on each shaft respectively; spur gear shaft 53 and armature shaft 31 are substantially in the same plane. Idle gear 48 is situated between spur gear 56 and drive gear 52, said gears 48 are substantially larger and rotate on shaft 58 while in engagement with both gear 56 and drive gear 52; said drive gear 52 rotate on shaft 50 and also used it as the output shaft. Cleat 57 provide means by which said torque coupling 37 may be fixedly attach to endframe 42 by attachment means. The center point of the components including the endframes are taken as one half its diameter, the size of the poleface and the adjacent space between said polefaces determine the size of the endframe. The embodiment at FIG. 1 show a motor having four armature shafts and the endframe for said motor is shown at FIG. 5, where a vertical and a horizontal line is drawn through the center of said endframe dividing it into four quadrant or 90° apart from each other. The radius of poleface 40 is taking with adjustment for sleeve 39, this measurement is taken from the position of the outer perimeter of said endframe along the vertical or horizontal line which will be the center of opening 55. The embodiment of FIG. 2 show a motor having three armature shafts, the endframe for said motor is shown at FIG. 6, the principle for shafts opening are the same except that those shafts opening are located 120° apart from each other. The embodiment of FIG. 3 show a motor having two armature shafts, the endframe for said motor is shown at FIG. 7 the principle for shafts opening are the same except that those shafts opening are located 180° apart.

Consideration would be appreciated to the fact that the present invention relate to a multiple shaft multiple discs armature electric motor, wherein two or more parallel armature shafts rotatable supported between endframes with each shaft rotating any required number of two or more armatures. At this time when the world call for clean renuable source of energy, there can be no doubt that the versatility of this device which can be configured to provide any required amount of torque and motive power; is the answer to that call.

The preferred embodiment of the present invention disclosed for the purpose of illustration, it is understood that many modification, dimensional variations and rearrangements can be made thereto; without departing from the invention. It is therefore intended to cover all such modification, dimensional variations and rearrangements which falls within the scope of the invention.

I claim:

1. A multiple shafts multiple discs armature electric motor comprising two or more armature shafts upon which plurality of discs shaped magnetic polefaces are disposed, plurality of discs shaped armature windings are also disposed between each poleface on said armature shaft; said shafts are rotatably supported between first and second endframes with said shafts extending beyond first endframe, elongated support strut associated with each endframe are fixedly mounted between each said endframes which define the outer permimeter of the device; torque coupling means is in alignment with said first endframe, said coupling means comprising a housing, multiple spur gears, multiple idle gears, and a drive gear located within said housing with said drive gear rotating on the out put shaft; multiple spur gears shafts extended a short distant beyond said housing, each of said spur gear shaft being attached to a different one of said armature shafts, said idle gears being situated between and in engagement with spur and drive gear.

2. A multiple shafts multiple armature motor of claim 1 wherein any required numbre of two or more armature shafts, and any required number of two or more armature windings disposed on each said armature shafts in a unit.

3. A multiple shafts multiple armatures motor of claim 1 wherein, a aperture is provided in each poleface through which each armature shaft rotate without touching said poleface.

4. A multiple shafts multiple armatures motor of claim 1 wherein, a torque coupling spur gears and fhafts, attach to each different armature shaft and transfer motive power via idle gears to a drive gear where all power is combine, and said total power is available at the output shaft.

5. a multiple shafts multiple armatures motor of claim 1 wherein, a torque coupling gearbox use any required number of two or more spur gears with shafts to attach to any required number of two or more armature shafts in a unit.

6. A multiple shafts multiple armatures motor of claim 1 wherein, the motor of claim 1 comprising two armature shafts, and three armature windings disposed on each shaft.

7. A multiple shafts multiple armatures motor of claim 1 wherein, the motor of claim 1 comprising three armature shafts, and three armature windings disposed on each shaft.

8. A multiple shafts multiple armatures motor of claim 1 wherein, the motor of claim 1 comprising four armature shafts, and three armature windings disposed on each shaft.
